(19) United States
(12) Patent Application Publication
(10) Pub. No.: US 2026/0006352 A1
(43) Pub. Date: Jan. 1, 2026

(54) COUNTER READOUT CIRCUIT AND CONTROL METHOD

(71) Applicant: Smartsens Technology (HK) Co., Limited, Hongkong (CN)

(72) Inventors: Yunqi WANG, Shanghai (CN); Xiaoxing LI, Shanghai (CN)

(73) Assignee: Smartsens Technology (HK) Co., Limited, Hongkong (CN)

(21) Appl. No.: 19/001,524

(22) Filed: Dec. 25, 2024

(30) Foreign Application Priority Data
Jun. 27, 2024 (CN) 202410850110.0
Jun. 27, 2024 (CN) 202421508934.1

(51) Int. Cl. H04N 25/78; H04N 23/65; H04N 25/75

(52) U.S. Cl. CPC H04N 25/78; H04N 23/651; H04N 25/75

(57) ABSTRACT

The present application provides a counter readout circuit and control method, each counter unit is connected to a counter readout circuit. The first selector's first input end is connected to the corresponding counter unit, and the second input end is connected to the data output signal of the lower-level counter readout circuit. The control end of the first selector receives a first selection signal to select the first input end or the second input end. The output end of the first selector is connected to the input end of the first trigger, and the output end of the first trigger outputs the data output signal of the counter readout circuit. The trigger end of the first trigger is coupled to the second input end of the first selector of the higher-level counter readout circuit. The technical solution of this application can effectively reduce the power consumption of the image sensor.

### CROSS-REFERENCE TO RELATED APPLICATIONS

This application is based upon and claims the priority to Chinese Patent Application No. 202410850110.0 and No. 202421508934.1, filed on Jun. 27, 2024, which are incorporated herein by reference in them entirety.

### TECHNICAL FIELD

The present application relates to the field of image sensor technology, specifically involving a counter readout circuit and control method.

### BACKGROUND

Image sensors have been widely applied in imaging fields such as video, surveillance, industrial manufacturing, automotive, and home appliances. The counter and its readout circuit within the image sensor are important components of its analog-to-digital circuit, which quantize analog quantities into digital signals and transmit them to the digital processing module for further processing.

During the conception and development of this application, the applicant found that due to the high-speed clock used in the counting and reading process, the power consumption of the counter in the image sensor is relatively high. Therefore, optimizing its power consumption is of great significance for the overall performance improvement of the image sensor chip.

### SUMMARY OF THE DISCLOSURE

To alleviate the aforementioned issues, this application provides a counter readout circuit and control method, wherein the counter readout circuit applied to a counter, the counter comprises a plurality of counter units; each the counter unit connected to one counter readout circuit; the counter readout circuit comprises a first selector and a first trigger:
a first input end of the first selector connected to a corresponding counter unit, a second input end of the first selector connected to a data output signal of a lower-level counter readout circuit, a control end of the first selector receiving a first selection signal to select the first input end or second input end;
an output end of the first selector connected to an input end of the first trigger, an output end of the first trigger outputting the an data output signal of the counter readout circuit, a trigger end of the first trigger coupled to a control end of the first selector of a higher-level counter readout circuit.

In one embodiment, the counter readout circuit further comprises a signal trigger unit, the signal trigger unit is connected between the trigger end of the first trigger and the control end of the first selector of the higher-level counter readout circuit, the signal trigger unit is configured to generate a trigger signal of the first trigger of the counter readout circuit based on a first selection signal of the higher-level counter readout circuit.

In one embodiment, the signal trigger unit comprises a second trigger, an input end of the second trigger is connected to an enable signal, a trigger end of the second trigger is connected to the control end of the first selector of the higher-level counter readout circuit; an output end of the second trigger is coupled to the trigger end of the first trigger.

In one embodiment, the signal trigger unit further comprises an AND gate, a first input end of the AND gate is connected to a clock signal, a second input end of the AND gate is connected to the output end of the second trigger, an output end of the AND gate is connected to the trigger end of the first trigger.

In one embodiment, trigger modes of the first trigger and the second trigger are selected from the group consisting of a rising edge trigger mode, a falling edge trigger mode, a level trigger mode, and a pulse trigger mode.

In one embodiment, each counter unit comprises multiple storage spaces; the counter readout circuit further comprises a second selector, multiple input ends of the second selector respectively connected to a storage space of the corresponding counter unit;
a control end of the second selector is connected to a second selection signal to select each storage space of the counter unit, an output end of the second selector is connected to the first input end of the first selector.

In one embodiment, the counter readout circuit further comprises a load enhancement unit, the load enhancement unit is connected between the second input end of the first selector and an output end of a first trigger of a lower-level counter readout circuit, and/or, the load enhancement unit is connected between the output end of the first trigger and a second input end of a first selector of the higher-level counter readout circuit.

In one embodiment, the load enhancement unit comprises a first NOT gate and a second NOT gate connected in series, an input end of the first NOT gate is connected to receive the data output signal, an output end of the first NOT gate is connected to the input end of the second NOT gate, an output end of the second NOT gate is configured to output a processed data output signal.

In one embodiment, the control method comprises:
actuating a trigger signal of the first trigger of the highest-level counter readout circuit in a cascading order of multiple counter readout circuits, and selecting a first input end of a first selector of a highest-level counter readout circuit to read the data of the counter unit corresponding to the highest-level counter readout circuit;
when the reading of a counter unit corresponding to a higher-level counter readout circuit is completed, selecting a second input end of a first selector of the higher-level counter readout circuit, and actuating a trigger signal of a first trigger of an adjacent lower-level counter readout circuit based on a first selection signal of the higher-level counter readout circuit, and selecting a first input end of a first selector of the lower-level counter readout circuit, to read data of a counter unit corresponding to the lower-level counter readout circuit.

In one embodiment, in the process of actuating the trigger signal of the first trigger of the adjacent lower-level counter readout circuit based on the first selection signal of the higher-level counter readout circuit, the trigger signal of the first trigger of the adjacent lower-level counter readout circuit is triggered at the start of a first selection signal of the higher-level counter readout circuit.

The counter readout circuit and control method provided by the present application connect a counter readout circuit to each counter unit; the counter readout circuit includes a first selector and a first trigger: the first input end of the first selector is connected to the corresponding counter unit, the second input end of the first selector is connected to the data output signal of the lower-level counter readout circuit, the control end of the first selector receives a first selection signal to select the first input end or the second input end; the output end of the first selector is connected to the input end of the first trigger, the output end of the first trigger outputs the data output signal of the counter readout circuit, and the trigger end of the first trigger is coupled to the control end of the first selector of the higher-level counter readout circuit. This can solve the problem of high power consumption of the counter and its readout circuit, effectively reducing the power consumption of the image sensor and improving the user experience.

### BRIEF DESCRIPTION OF THE DRAWINGS

The accompanying drawings incorporated herein and forming a part of this specification illustrate the embodiments of the present application and, together with the description, serve to explain the principles of the present application. To better illustrate the technical solution of the embodiment of the present application, a brief introduction to the drawings required in the description of the embodiment will be provided below. It is evident that, for ordinary technicians in this field, additional drawings can be obtained based on these drawings without the need for creative effort.

FIG. 1 is a schematic diagram of the counter structure connection in one embodiment of the present application.

FIG. 2 is a schematic diagram of the counter readout circuit connection in one embodiment of the present application.

FIG. 3 is a schematic diagram of the key node timing in the counter readout circuit in one embodiment of the present application.

FIG. 4 is a flowchart of the control method in one embodiment of the present application.

The objectives, functional features, and advantages of the present application will be further explained in conjunction with the embodiments, with reference to the drawings. Through the aforementioned drawings, clear embodiments of the present application are shown, and a more detailed description will be provided in the following text. These drawings and textual descriptions are not intended to limit the scope of the present application in any way, but rather to illustrate the concepts of the present application to technicians in the field by reference to specific embodiments.

### DETAILED DESCRIPTION

This section will provide a detailed description of the exemplary embodiments, which are illustrated in the accompanying drawings. The following description refers to the accompanying drawings, and unless otherwise indicated, the same numbers in different drawings represent the same or similar elements. The implementation methods described in the following exemplary embodiments do not represent all possible implementations consistent with the present application. Instead, they are merely examples of devices and methods that are consistent with some aspects of the present application as detailed in the appended claims.

It should be noted that in this document, the terms “include,” “comprise,” or any other variations are intended to encompass a non-exclusive inclusion, meaning that a process, method, article, or device that includes a series of elements includes those elements and also includes other elements that are not explicitly listed, or includes elements inherent to such a process, method, article, or device. In the absence of additional limitations, the element limited by the phrase “including a . . . ” does not exclude the presence of other identical elements in the process, method, article, or device that includes that element. Furthermore, components, features, or elements with the same name in different embodiments of the application may have the same or different meanings, and their specific meanings should be determined based on their interpretation in that specific embodiment or in conjunction with the context of that specific embodiment.

It should be understood that the specific embodiments described here are merely for the purpose of explaining the present application and are not intended to limit the scope of the application.

### First Embodiment

The present application provides a counter readout circuit and control method, said counter readout circuit applied to a counter, as shown in FIG. 1, which is a schematic diagram of the counter structure connection in one embodiment of the present application.

As shown in FIG. 1, the counter includes multiple counter units (illustrated as a first counter unit to a nth counter unit in the FIG. 1, where n is a natural number); each counter unit is connected to a counter readout circuit, and the counter readout circuit is also called the counter readout cell (illustrated as the first counter readout cell to the nth counter readout cell in the FIG. 1, wherein n is a natural number).

Exemplarily, the counter and its counter readout cell are important components of the analog-to-digital circuit, which quantize analog quantities into digital signals and transmit them to the digital processing module for further processing. Since both counting and reading use high-speed clocks, their power consumption is relatively large, and optimizing this power consumption is significant for the performance of the chip.

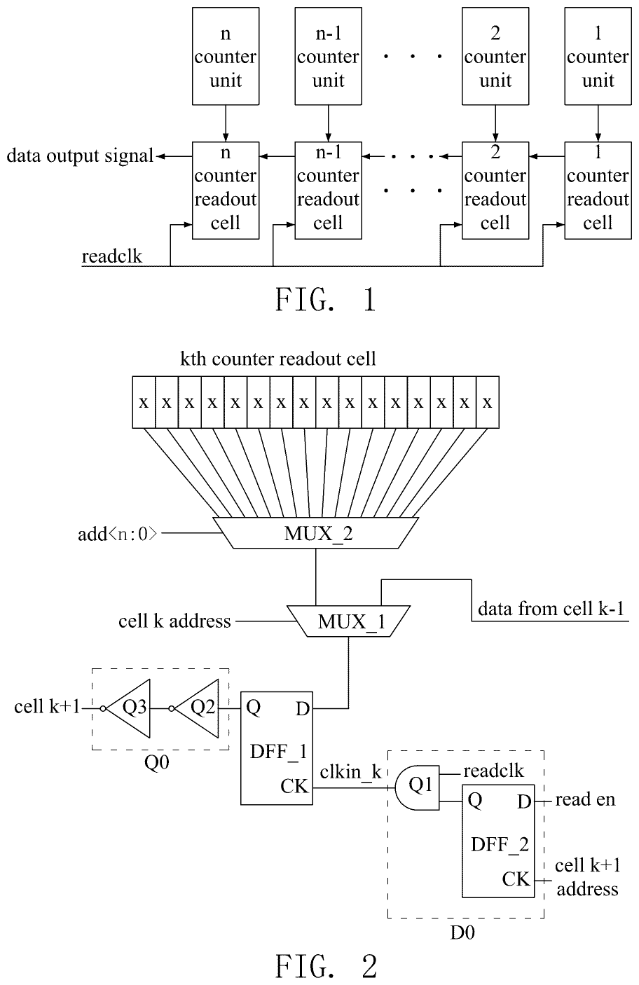

FIG. 2 is a schematic diagram of the counter readout circuit connection in one embodiment of the present application.

As shown in FIG. 2, a kth counter readout cell (wherein k is a natural number greater than 0 and less than or equal to n) includes a first selector MUX 1 and a first trigger DFF_1.

The first input end of the first selector MUX 1 is connected to the corresponding counter unit, the second input end of the first selector MUX 1 is connected to the data output signal (i.e., data from cell k−1 as shown in FIG. 2) of the lower-level counter readout cell, i.e., (k−1)th counter readout cell, and the control end of the first selector MUX_1 receives a first selection signal (i.e., cell k address as shown in FIG. 2) to select the first input end or the second input end.

The output end of the first selector MUX_1 is connected to the input end of the first trigger DFF_1, the output end of the first trigger DFF_1 outputs the data output signal (i.e., data to cell k+1 as shown in FIG. 2), and the trigger end of the first trigger DFF_1 is coupled to the control end of the first selector of the higher-level counter readout cell (i.e., (k+1)th counter readout cell) to receive its first selection signal (i.e., cell k+1 address as shown in FIG. 2).

Referencing FIG. 1, exemplarily, the counter and counter readout circuit are divided into n groups, with data from the counter unit being transmitted to the corresponding counter readout cell and read out sequentially from the nth group's data, the (n−1)th group's data, all the way to the first group's data through the clock signal readclk, thereby completely transmitting the data from the counter unit out.

Referencing FIG. 2, the data output signal of the kth counter readout cell (i.e., data to cell k+1 in FIG. 2) is transmitted to the first selector of the higher-level counter readout cell (i.e., (k+1)th counter readout cell). Correspondingly, the data output signal received by the first selector MUX_1 of the kth counter readout cell is the data from cell k−1, achieving connection between all levels. Specifically, taking the kth counter readout cell as an example, the x in the box in FIG. 2 represents the data counted by the counter unit, with a value of 0 or 1. Under normal circumstances, the kth counter readout cell has two working modes. The first mode is when cell k address takes a value of 1, it can work by reading the data of this group, and then by alternating changes of add<n:0>, the counter unit data is sequentially selected to the input end of the first trigger DFF_1 and output by the clock signal (i.e., read clk as shown in FIG. 2). The second mode is when cell k address takes a value of 0, it can work in data transmission mode, where the first selector MUX 1 transmits the data of the lower-level counter readout cell (i.e., (k−1)th counter readout cell) to the input end of the first trigger DFF_1, and to output it according to the readclk and the coupling signal of the cell k+1 address of the higher-level counter readout cell (i.e., (k+1)th counter readout cell). After signal coupling, before the kth counter readout cell reads the data of cell k+1, since its cell k+1 address is 0, the enable signal (i.e., read_en in FIG. 2) cannot be transmitted backward, and the coupling signal (i.e., clkin_k in FIG. 2) remains 0, meaning that before reading the data of the (k+1)th counter readout cell, counter readout cells from the kth to the first will not transmit signals, and thus there is no power consumption. When it reads the data of counter readout cell k+1, cell k+1 address is 1, read_en is transmitted to AND gate Q1, at which point the coupling signal clkin_k is consistent with the clock signal readclk, thus entering the normal working state.

Throughout the entire working cycle of this embodiment, since there is no power consumption loss when each counter readout circuit unit reads data, the entire system effectively reduces working power consumption.

Referencing FIG. 2, optionally, the kth counter readout cell also includes a signal trigger unit DO, which is connected between the trigger end of the first trigger DFF_1 and the control end of the first selector of the higher-level counter readout cell (i.e., (k+1)th counter readout cell), the signal trigger unit DO generates a trigger signal for the first trigger DFF_1 of the current-level counter readout cell based on the first selection signal of the higher-level counter readout cell (i.e., cell k+1 address signal in FIG. 2), which is the trigger signal for the first trigger DFF_1 of the kth counter readout cell (i.e., clkin_k in FIG. 2).

Referencing FIG. 2, optionally, the signal trigger unit DO includes a second trigger DFF_2, the input end of which is connected to the enable signal (i.e., read_en in FIG. 2), the trigger end of which is connected to the second input end of the first selector of the higher-level counter readout cell (i.e., (k+1)th counter readout cell); the output end of the second trigger DFF_2 is coupled to the trigger end of the first trigger DFF_1.

Exemplarily, a trigger is a memory function device with two stable states, which is the most basic logical unit constituting various timing circuits and an important unit circuit in digital logic circuits. Therefore, triggers have a wide range of applications in digital systems and computers. Exemplarily, a D flip-flop has two stable states, 0 and 1, and can flip from one stable state to another under the action of certain external signals.

Referencing FIG. 2, optionally, the signal trigger unit DO includes an AND gate Q1, the first input end of which is connected to the clock signal (i.e., readclk in FIG. 2), the second input end of the AND gate Q1 is connected to the output end of the second trigger DFF_2, and the output end of which is connected to the trigger end of the first trigger DFF_1.

An AND gate, also known as an “AND circuit,” logical “product,” or logical “AND” circuit, is a basic logic gate circuit that performs “AND” operations. It has multiple input ends and one output end.

The output is high (logic 1) only when all inputs are high; otherwise, the output is low (logic 0). The AND gate is a circuit that implements logical “multiplication” operations, with two or more input ends and one output end (most circuits have only one output end, while ECL circuits have two). The circuit output is high (logic “1”) only when all input ends are high; otherwise, the output is low (logic “0”). Exemplarily, when the clock signal (i.e., readclk in FIG. 2) and the signal output by the second trigger DFF_2 are both high, the output end of AND gate Q1 will output a high level.

Referencing FIG. 2, optionally, the trigger mode of the first trigger DFF_1 and the second trigger DFF_2 is selected from the group consisting of rising edge trigger mode, falling edge trigger mode, level trigger mode, and pulse trigger mode.

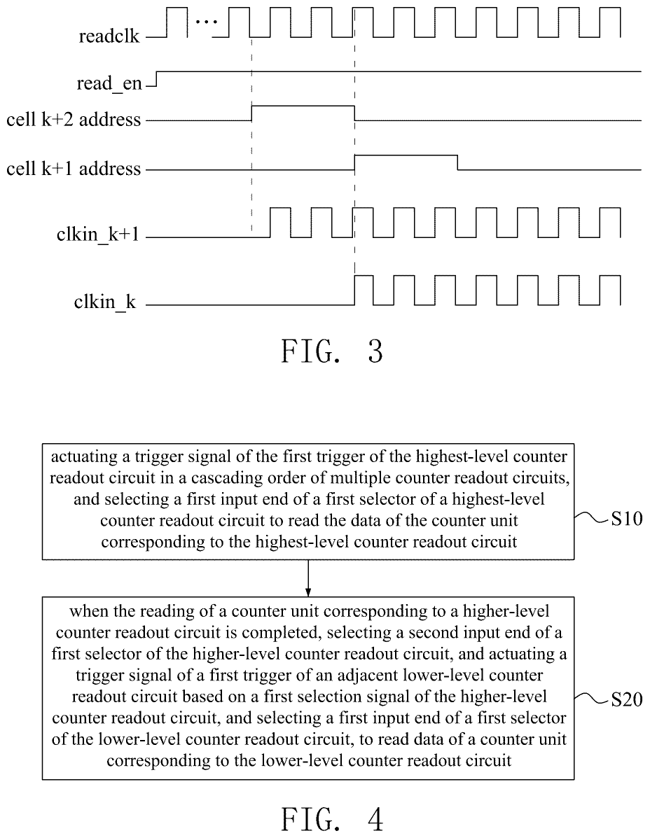

FIG. 3 is a schematic diagram of key node timing in the counter readout circuit of one embodiment of the present application.

Referencing FIG. 3, under the drive of the clock signal (i.e., readclk in FIG. 2), when the counter readout cell needs to work, the enable signal (i.e., read_en in FIG. 2) is adjusted from a low level to a high level. The counter readout circuit sequentially adjusts the first selection signal (i.e., cell k+2 address and cell k+1 address in FIG. 3) to a high level during the readout stage. At the rising edge of the first selection signal of the higher-level counter readout cell (i.e., (k+1)th counter readout cell), the coupling signal (i.e., clkin_k in FIG. 2) of the current-level counter readout cell (i.e., kth counter readout cell) is triggered to start.

It should be noted that, for system robustness, this embodiment adopts a rising edge trigger mode, where the kth counter readout cell starts working while the (k+1)th counter readout cell is reading data, retaining some margin to ensure that there are no data error issues in the first one or two clocks of the kth counter readout cell. In another embodiment, considering better robustness, more margin can be reserved, and the start time of the kth counter readout cell can be advanced. In other embodiments, a falling edge trigger mode can also be used, where the (k+1)th counter readout cell finishes reading before the kth counter readout cell starts, minimizing system power consumption. The appropriate start time can be selected based on actual system requirements, and this application does not limit it.

Exemplarily, assuming that there are n groups of counter units and counter readout circuits, and the power consumption required for a single counter readout circuit to read out the signals of this group is P, then using the technical solution of this embodiment, the power consumption required to read all data is

$$P \times \frac{{n}^{2} + n}{2} .$$

When the amount of data is large and n takes a larger value, compared to the traditional readout scheme, which requires a power consumption of P×n² to read all data, the low-power readout module circuit of this embodiment can reduce power consumption by nearly half, which is significant.

### Second Embodiment

Building on the above embodiment, referencing FIG. 2, optionally, each counter unit includes multiple storage spaces, each storing counted data x; the kth counter readout cell also includes a second selector MUX_2, the multiple input ends of which are respectively connected to a storage space of the corresponding counter unit; it can be understood that in this embodiment, a group of counter readout cells includes 16 counter data, and the corresponding address add<n:0> can be set to add<3:0> to output this group of data based on the address add<3:0>. In other embodiments, a counter readout cell includes 8 counter data, and the corresponding address add<n:0> can be set to add<2:0> to output this group of data based on the address add<2:0>. Therefore, in actual applications, a group of counter readout cells can be designed to include more or fewer counter data and output after configuring the corresponding address, which is not limited here.

The control end of the second selector MUX_2 is connected to the second selection signal (add<n:0> signal in FIG. 2) to select each storage space of the counter unit, and the output end of the second selector MUX_2 is connected to the first input end of the first selector MUX 1.

Exemplarily, the counter is addressed and selected through the second selection signal, the second selector is driven to conduct the corresponding storage space, so that the data of the storage space corresponding to the counter unit is sequentially output to the first selector.

Referencing FIG. 2, optionally, the counter readout circuit also includes a load enhancement unit Q0, which is connected between the second input end of the first selector MUX_1 and the output end of the first trigger DFF_1 of the lower-level counter readout cell (i.e., (k−1)th counter readout cell), and/or between the output end of the first trigger DFF_1 and the control end of the first selector of the higher-level counter readout cell (i.e., (k+1)th counter readout cell).

Exemplarily, the signal output by the trigger may have limited power and limited load capacity. Therefore, the signal output by the first trigger can be enhanced through the load enhancement unit.

Referencing FIG. 2, optionally, the load enhancement unit Q0 includes a first NOT gate Q2 and a second NOT gate Q3 connected in series, the input end of which is connected to the data output signal, and the output end of which is connected to the input end of the second NOT gate Q3, and the output end of the second NOT gate Q3 outputs the processed data output signal.

Exemplarily, by performing two NOT operations on the signal output by the first trigger DFF_1, the load capacity of the data output signal output by the first trigger DFF_1 can be effectively improved, avoiding data errors during data transmission, and effectively improving the accuracy of data transmission.

### Third Embodiment

The present application also provides a control method applied to the counter readout circuit as described above, FIG. 4 is a flowchart of the control method in one embodiment of the present application.

As shown in FIG. 4, in one embodiment, the control method includes: S10: actuating a trigger signal of the first trigger of the highest-level counter readout circuit in a cascading order of multiple counter readout circuits, and selecting a first input end of a first selector of a highest-level counter readout circuit to read the data of the counter unit corresponding to the highest-level counter readout circuit. S20: when the reading of a counter unit corresponding to a higher-level counter readout circuit is completed, selecting a second input end of a first selector of the higher-level counter readout circuit, and actuating a trigger signal of a first trigger of an adjacent lower-level counter readout circuit based on a first selection signal of the higher-level counter readout circuit, and selecting a first input end of a first selector of the lower-level counter readout circuit, to read data of a counter unit corresponding to the lower-level counter readout circuit.

Referencing FIGS. 1 to 3, the data output signal of the kth counter readout cell (data to cell k+1 signal) is transmitted to the first selector of the higher-level counter readout cell, i.e., (k+1)th counter readout cell. Correspondingly, the data output signal received by the first selector MUX_1 of the kth counter readout cell is the data from cell k−1 signal, achieving connection between all levels. Specifically, taking the kth counter readout cell as an example, the x in the box in the figure represents the data counted by the counter unit, with a value of 0 or 1. Under normal circumstances, the kth counter readout cell has two working modes. The first mode is when cell k address takes a value of 1, it can work by reading the data of this group, and then by alternating changes of add<3:0>, the counter unit data is sequentially selected to the input end of the first trigger DFF_1 and output by the clock signal (i.e., read clk). The second mode is when cell k address takes a value of 0, it can work in data transmission mode, where the first selector MUX 1 transmits the data of the lower-level counter readout cell (i.e., (k−1)th counter readout cell) to the input end of the first trigger DFF_1 and output with the readclk and the coupling signal of the cell k+1 address of the higher-level counter readout cell (i.e., (k+1)th counter readout cell). After signal coupling, before the kth counter readout cell reads the data of cell k+1, since its cell k+1 address is 0, the enable signal (i.e., read_en) cannot be transmitted backward, and clkin_k remains 0, meaning that before reading the data of counter readout cell k+1, counter readout cells from the kth to the first will not transmit signals, and thus there is no power consumption. When it reads the data of the (k+1)th counter readout cell, cell k+1 address is 1, read_en is transmitted to AND gate, at which point the clkin_k is consistent with the clock signal readclk, thus entering the normal working state.

Throughout the entire working cycle of this embodiment, since there is no power consumption loss when each counter readout circuit unit reads data, the entire system effectively reduces working power consumption.

Optionally, in the process of actuating the trigger signal of the first trigger of the adjacent lower-level counter readout circuit based on the first selection signal of the higher-level counter readout circuit, the trigger signal of the first trigger of the lower-level counter readout circuit is triggered at the start of the first selection signal of the higher-level counter readout circuit.

Referencing FIGS. 1 to 3, under the drive of the clock signal (readclk in FIG. 2), when the counter readout cell needs to work, the enable signal (i.e., read_en in FIG. 2) is adjusted from a low level to a high level. The counter readout circuit sequentially adjusts the first selection signal (i.e., cell k+2 address and cell k+1 address in FIG. 3) to a high level during the readout stage. At the rising edge of the first selection signal of the higher-level counter readout cell (i.e., (k+1)th counter readout cell), the coupling signal (i.e., clkin_k in FIG. 2) of the current-level counter readout cell (i.e., kth counter readout cell) is triggered to start.

Exemplarily, assuming that there are n groups of counter units and counter readout circuits, and the power consumption required for a single counter readout circuit to read out the signals of this group is P, then using the technical solution of this embodiment, the power consumption required to read all data is P×n²+n/2. When the amount of data is large and n takes a larger value, compared to the traditional readout scheme, which requires a power consumption of P×n² to read all data, the low-power readout module circuit of this embodiment can reduce power consumption by nearly half, which is significant.

The counter readout circuit and control method provided by the present application connect a counter readout circuit to each counter unit; the counter readout circuit includes a first selector and a first trigger: the first input end of the first selector is connected to the corresponding counter unit, the second input end of the first selector is connected to the data output signal of the lower-level counter readout circuit, the control end of the first selector receives a first selection signal to select the first input end or the second input end; the output end of the first selector is connected to the input end of the first trigger, the output end of the first trigger outputs the data output signal of the counter readout circuit, and the trigger end of the first trigger is coupled to the control end of the first selector of the higher-level counter readout circuit. This can solve the problem of high power consumption of the counter and its readout circuit, effectively reducing the power consumption of the image sensor and improving the user experience.

It should be noted that in this application, step designations such as S10 and S20 are used to clearly and briefly describe the corresponding content and do not constitute substantial limitations on the order. Technicians in this field may execute S20 before S10, etc., in actual implementation, but these should all be within the scope of protection of this application.

In the embodiments of the image sensor and storage medium provided in this application, any of the above method embodiments can include all the technical features, and the content of the specification expansion and explanation is basically the same as the above method embodiments, and will not be repeated here.

The embodiments of this application also provide a computer program product, which includes computer program code. When the computer program code is run on a computer, it causes the computer to execute methods in any of the above possible embodiments.

The embodiments of this application also provide a chip, including a memory and a processor. The memory is used to store computer programs, and the processor is used to call and run computer programs from the memory, causing devices equipped with the chip to execute methods in any of the above possible embodiments.

It can be understood that the above scenarios are only as examples and do not constitute a limitation on the application scenarios of the technical solution provided by the embodiments of this application. The technical solution of the embodiments of this application can also be applied to other scenarios. For example, as ordinary technicians in this field know, with the evolution of system architecture and the emergence of new business scenarios, the technical solution provided by the embodiments of this application is also applicable to similar technical problems.

The sequence numbers of the embodiments in this application are only for description and do not represent the superiority or inferiority of the embodiments.

The steps in the method embodiments of this application can be adjusted in order, merged, and deleted according to actual needs.

The units in the device embodiments of this application can be merged, divided, and deleted according to actual needs.

In this application, for the same or similar terms, technical solutions, and/or application scenario descriptions, a detailed description is generally only provided the first time they appear. To be concise, they are generally not repeated when they appear again. When understanding the technical solutions and other contents of this application, for the same or similar terms, technical solutions, and/or application scenario descriptions that are not described in detail later, reference can be made to the previous related detailed descriptions.

In this application, the descriptions of each embodiment have their own focus. Parts that are not described in detail or recorded in a certain embodiment can refer to the related descriptions of other embodiments.

The technical features of the technical solution of this application can be combined arbitrarily. To make the description concise, not all possible combinations of the technical features in the above embodiments are described. However, as long as there are no contradictions in the combination of these technical features, they should be considered within the scope of this application.

The above is only the preferred embodiment of this application and does not limit the scope of this application. All equivalent structures or equivalent process transformations made using the content of this application's specification and drawings, or directly or indirectly applied in other related technical fields, are similarly included within the scope of patent protection of this application.

What is claimed is:

1. A counter readout circuit, wherein the counter readout circuit is applied to a counter, the counter comprises a plurality of counter units; each the counter unit connected to one counter readout circuit; the counter readout circuit comprises a first selector and a first trigger:
a first input end of the first selector connected to a corresponding counter unit, a second input end of the first selector connected to a data output signal of a lower-level counter readout circuit, a control end of the first selector receiving a first selection signal to select the first input end or second input end;
an output end of the first selector connected to an input end of the first trigger, an output end of the first trigger outputting the an data output signal of the counter readout circuit, a trigger end of the first trigger coupled to a control end of a first selector of a higher-level counter readout circuit.

2. The counter readout circuit according to claim 1, wherein, the counter readout circuit further comprises a signal trigger unit, the signal trigger unit is connected between the trigger end of the first trigger and the control end of the first selector of the higher-level counter readout circuit, the signal trigger unit is configured to generate a trigger signal of the first trigger of the counter readout circuit based on a first selection signal of the higher-level counter readout circuit.

3. The counter readout circuit according to claim 2, wherein, the signal trigger unit comprises a second trigger, an input end of the second trigger is connected to an enable signal, a trigger end of the second trigger is connected to the control end of the first selector of the higher-level counter readout circuit; an output end of the second trigger is coupled to the trigger end of the first trigger.

4. The counter readout circuit according to claim 3, wherein, the signal trigger unit further comprises an AND gate, a first input end of the AND gate is connected to a clock signal, a second input end of the AND gate is connected to the output end of the second trigger, an output end of the AND gate is connected to the trigger end of the first trigger.

5. The counter readout circuit according to claim 3, wherein, trigger modes of the first trigger and the second trigger are selected from the group consisting of a rising edge trigger mode, a falling edge trigger mode, a level trigger mode, and a pulse trigger mode.

6. The counter readout circuit according to claim 1, wherein, each counter unit comprises multiple storage spaces; the counter readout circuit further comprises a second selector, multiple input ends of the second selector are respectively connected to a storage space of the corresponding counter unit;
a control end of the second selector is connected to a second selection signal to select each storage space of the counter unit, an output end of the second selector is connected to the first input end of the first selector.

7. The counter readout circuit according to claim 2, wherein, each counter unit comprises multiple storage spaces; the counter readout circuit further comprises a second selector, multiple input ends of the second selector respectively are connected to a storage space of the corresponding counter unit;
a control end of the second selector is connected to a second selection signal to select each storage space of the counter unit, an output end of the second selector is connected to the first input end of the first selector.

8. The counter readout circuit according to claim 3, wherein, each counter unit comprises multiple storage spaces; the counter readout circuit further comprises a second selector, multiple input ends of the second selector are respectively connected to a storage space of the corresponding counter unit;
a control end of the second selector is connected to a second selection signal to select each storage space of the counter unit, an output end of the second selector is connected to the first input end of the first selector.

9. The counter readout circuit according to claim 4, wherein, each counter unit comprises multiple storage spaces; the counter readout circuit further comprises a second selector, multiple input ends of the second selector are respectively connected to a storage space of the corresponding counter unit;
a control end of the second selector is connected to a second selection signal to select each storage space of the counter unit, an output end of the second selector is connected to the first input end of the first selector.

10. The counter readout circuit according to claim 5, wherein, each counter unit comprises multiple storage spaces; the counter readout circuit further comprises a second selector, multiple input ends of the second selector respectively connected to a storage space of the corresponding counter unit;
a control end of the second selector is connected to a second selection signal to select each storage space of the counter unit, an output end of the second selector is connected to the first input end of the first selector.

11. The counter readout circuit according to claim 1, wherein, the counter readout circuit further comprises a load enhancement unit, the load enhancement unit is connected between the second input end of the first selector and an output end of a first trigger of a lower-level counter readout circuit, and/or, the load enhancement unit is connected between the output end of the first trigger and a second input end of a first selector of the higher-level counter readout circuit.

12. The counter readout circuit according to claim 2, wherein, the counter readout circuit further comprises a load enhancement unit, the load enhancement unit is connected between the second input end of the first selector and an output end of a first trigger of a lower-level counter readout circuit, and/or, the load enhancement unit is connected between the output end of the first trigger and a second input end of a first selector of the higher-level counter readout circuit.

13. The counter readout circuit according to claim 3, wherein, the counter readout circuit further comprises a load enhancement unit, the load enhancement unit is connected between the second input end of the first selector and an output end of a first trigger of a lower-level counter readout circuit, and/or, the load enhancement unit is connected between the output end of the first trigger and a second input end of a first selector of the higher-level counter readout circuit.

14. The counter readout circuit according to claim 4, wherein, the counter readout circuit further comprises a load enhancement unit, the load enhancement unit is connected between the second input end of the first selector and an output end of a first trigger of a lower-level counter readout circuit, and/or, the load enhancement unit is connected between the output end of the first trigger and a second input end of a first selector of the higher-level counter readout circuit.

15. The counter readout circuit according to claim 5, wherein, the counter readout circuit further comprises a load enhancement unit, the load enhancement unit is connected between the second input end of the first selector and an output end of a first trigger of a lower-level counter readout circuit, and/or, the load enhancement unit is connected between the output end of the first trigger and a second input end of a first selector of the higher-level counter readout circuit.

16. The counter readout circuit according to claim 11, wherein, the load enhancement unit comprises a first NOT gate and a second NOT gate connected in series, an input end of the first NOT gate is configured to receive the data output signal, an output end of the first NOT gate is connected to the input end of the second NOT gate, an output end of the second NOT gate is configured to output a processed data output signal.

17. A control method, wherein, the control method applied to the counter readout circuit as described in claim 1, the control method comprises:
actuating a trigger signal of the first trigger of the highest-level counter readout circuit in a cascading order of multiple counter readout circuits, and selecting a first input end of a first selector of a highest-level counter readout circuit to read the data of the counter unit corresponding to the highest-level counter readout circuit;
when the reading of a counter unit corresponding to a higher-level counter readout circuit is completed, selecting a second input end of a first selector of the higher-level counter readout circuit, and actuating a trigger signal of a first trigger of an adjacent lower-level counter readout circuit based on a first selection signal of the higher-level counter readout circuit, and selecting a first input end of a first selector of the lower-level counter readout circuit, to read data of a counter unit corresponding to the lower-level counter readout circuit.

18. The control method according to claim 17, wherein, in the process of actuating the trigger signal of the first trigger of the adjacent lower-level counter readout circuit based on the first selection signal of the higher-level counter readout circuit, the trigger signal of the first trigger of the adjacent lower-level counter readout circuit is triggered at the start of a first selection signal of the higher-level counter readout circuit.
